(19) United States
(12) Patent Application Publication
(10) Pub. No.: US 2018/0359381 A1
(43) Pub. Date: Dec. 13, 2018

(54) IMAGE FORMING DEVICE

(71) Applicant: Konica Minolta Inc., Tokyo (JP)

(72) Inventor: TAKAO SHIBAZAKI, Toyokawa-shi Aichi (JP)

(21) Appl. No.: 16/004,945

(22) Filed: Jun. 11, 2018

(30) Foreign Application Priority Data
Jun. 13, 2017 (JP) 2017-115808

(51) Int. Cl. H04N 1/00; B65H 29/70; B65H 29/12; B65H 29/52

(52) U.S. Cl. CPC H04N 1/00647; H04N 1/00618; H04N 1/00602; B65H 29/52; B65H 29/70; B65H 29/125; H04N 1/00615

(57) ABSTRACT

There is provided an image forming device having a guide member that guides a sheet having passed through a fixing device to a pair of sheet ejection rollers, wherein the pair of sheet ejection rollers has pairs of sub-rollers installed at a rotary shaft at predetermined intervals, and a nip is formed by a pair of sub-rollers facing each other, the pairs of sub-rollers includes a specific pair of sub-rollers that nips an end region in a width direction orthogonal to a sheet conveyance direction when a sheet of a prescribed size passes, and the guide member includes a pressing member that presses a curl caused at an end region in the width direction of the sheet on a more upstream side in the sheet conveyance direction than a position where a leading end of the sheet enters a nip between the specific pair of sub-rollers.

### CROSS-REFERENCE TO RELATED APPLICATIONS

The present application claims priority under 35 U.S.C. § 119 to Japanese patent Application No. 2017-115808 filed on Jun. 13, 2017 the entire contents of which is incorporated herein by reference.

### BACKGROUND

### Technological Field

The present invention relates to an image forming device and particularly relates to a technology in which a sheet ejected from a sheet ejection roller after fixing is prevented from being wrinkled.

### Description of the Related Art

An electrophotographic image forming device such as a copy machine or a printer is provided with a fixing device that thermally fixes a toner image transferred on a sheet, and a sheet subjected to thermal fixing is ejected to a sheet ejection tray via a sheet ejection roller or fed to post processing device in a subsequent stage.
Patent Literature 1: JP 2000-143032 A

Meanwhile, it is found that in a case of feeding a sheet to a post processing device, the sheet is wrinkled depending on a size of a fed sheet when a passageway of the post processing device is curved.

A reason for this phenomenon is studied by the inventor of the present application, and it is found that a folded wrinkle is caused because: when an end region in a width direction orthogonal to a conveyance direction of the sheet (hereinafter simply referred to as “width direction”) passes through a nip between sheet ejection rollers in a curled state, a portion of the sheet located on a more inner side than the nip is deflected, and the sheet enters the curved portion of the passageway of the post processing device without correcting the deflected portion.

### SUMMARY

An object of the present invention is to provide an image forming device in which deflection in a sheet width direction is suppressed at the time of passing through a sheet ejection roller, and even in a case where there is a curved portion in a passageway of a post processing device or the like in a subsequent stage, a sheet is prevented from being wrinkled.

To achieve the abovementioned object, according to an aspect of the present invention, there is provided an image forming device, reflecting one aspect of the present invention, having a guide member that guides a sheet having passed through a fixing device to a pair of sheet ejection rollers, wherein the pair of sheet ejection rollers has a plurality of pairs of sub-rollers installed at a rotary shaft at predetermined intervals, and a nip is formed by a pair of sub-rollers facing each other, the plurality of pairs of sub-rollers includes a specific pair of sub-rollers that nips an end region in a width direction orthogonal to a sheet conveyance direction when a sheet of a prescribed size passes, and the guide member includes a pressing member that presses a curl in a direction to correct the curl, the curl being caused at an end region in the width direction of the sheet on a more upstream side in the sheet conveyance direction than a position where a leading end of the sheet enters a nip between the specific pair of sub-rollers.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view to describe a structure of an image forming system to which an image forming device according to an embodiment of the present invention is applied;

FIG. 2 is a view to describe main portions of a sheet ejection unit of an MFP and a sheet passageway of a post processing device in the image forming system;

FIG. 3 is a perspective view illustrating a structure of sheet ejection rollers of the MFP;

FIG. 4 is a view illustrating a curled state of a sheet having passed through a fixing device;

FIG. 5 is a view illustrating a state in which an edge on a leading end side of a curled sheet enters the sheet ejection rollers;

FIG. 6 is a view illustrating a state in which a sheet nipped between the sheet ejection rollers is deflected in the related art;

FIG. 7 is a view in a case of viewing the sheet ejection rollers and guide members on an upstream side thereof from a sheet ejection side in the embodiment of the present invention;

FIG. 8 is a schematic view illustrating a cross section taken along a line B-B in FIG. 7;

FIG. 9 is a perspective view in a case of viewing an upper guide member from below;

FIG. 10 is a view illustrating a modified example of a guide member;

FIG. 11 is a view illustrating another modified example of the guide member; and

FIG. 12 is a view illustrating still another modified example of the guide member.

### DETAILED DESCRIPTION OF EMBODIMENTS

Hereinafter, one or more embodiments of the present invention will be described with reference to the drawings. However, the scope of the invention is not limited to the disclosed embodiments.

In the following, an image forming device according to an embodiment of the present invention will be described by exemplifying an image forming system in which the image forming device and a post processing device are combined.

(1) External Appearance of Image Forming System

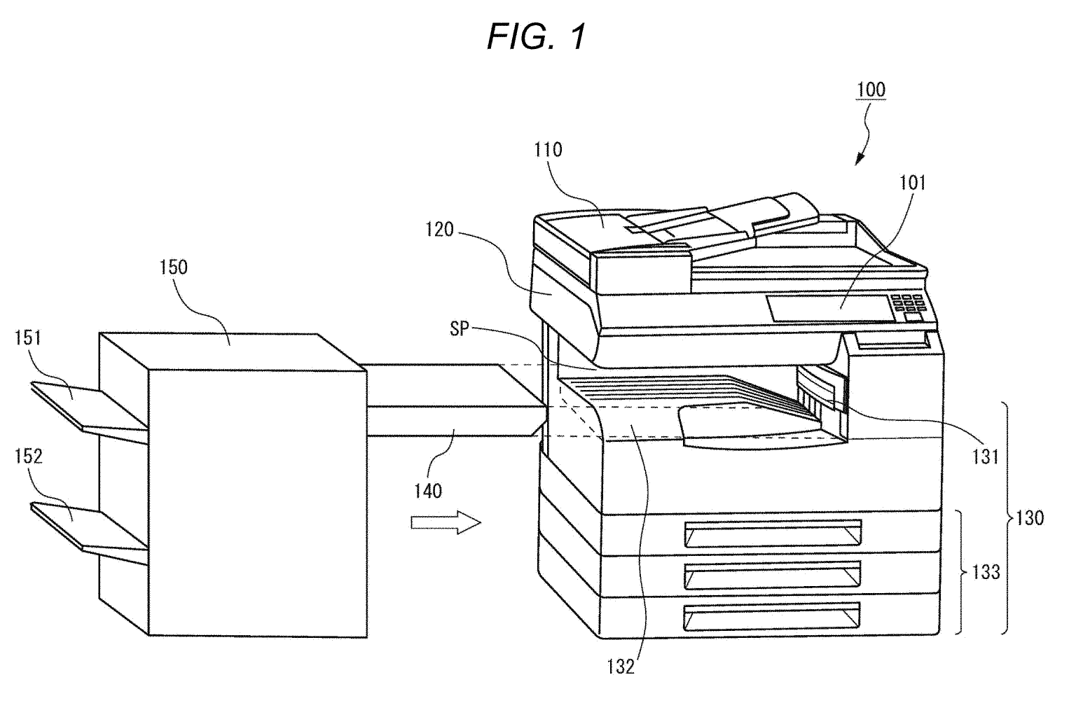

FIG. 1 is a perspective view illustrating an external appearance of an image forming system according to an embodiment of the present invention. This image forming system includes a multi-function peripheral (MFP) 100 as an image forming device, a relay unit 140, and a post processing device 150.

The MFP 100 also has functions as a scanner, a color copy machine, and a color laser printer.

As illustrated in FIG. 1, an automatic document feeder (ADF) 110 is mounted in an openable manner on an upper surface of a housing of the MFP 100. A scanner 120 is built in an upper portion of the housing located immediately under the ADF 110, and a printer 130 is built in a lower portion of this housing. A sheet feeding cassette 133 is attached to a lower portion of the printer 130 in a drawable manner.

This MFP 100 is a so-called in-body sheet ejection type. In other words, a sheet ejection tray 132 is detachably installed in a gap SP between the scanner 120 and the printer 130, and stores a sheet ejected from a sheet ejection port 131 located in a deep side of the gap SP.

A known electrophotographic printer is adopted as the printer 130. In other words, a peripheral surface of a photoreceptor drum is charged so as to have uniform potential, and then an electrostatic latent image is formed by performing exposure and scanning by an exposure device. In the structure, the electrostatic latent image is developed with a toner so as to form a toner image, and the toner image is transferred to a sheet fed from the sheet feeding cassette 133, then the toner image is thermally fixed by passing the sheet through a fixing device, and the sheet is ejected through a pair of sheet ejection rollers.

The relay unit 140 has a plurality of pairs of conveyance rollers arranged inside thereof, and plays a role to receive a sheet from the sheet ejection port 131 of the MFP 100 and convey the sheet to the post processing device 150.

The post processing device 150 performs, in accordance with a command from the MFP 100, post processing for a bundle of sheets received from the sheet ejection port 131 through the relay unit 140. This post processing includes, for example, processing to align a bundle of sheets, processing to staple the bundle with staples, and the like.

The post processing device 150 has two sheet ejection trays 151 and 152. In the upper sheet ejection tray 151, a sheet is stacked in a state fed from the sheet ejection port 131. In the lower sheet ejection tray 152, the bundle of sheets is stacked in a state aligned or stapled with staples.

When the post processing device 150 is coupled to the MFP 100, the sheet ejection tray 132 of the MFP 100 is removed, the post processing device 150 is moved in a direction indicated by an arrow, the relay unit 140 is inserted into the gap SP, and the sheet ejection port 131 of the MFP 100 and a sheet entrance port of the relay unit 140 are set so as to face each other. Additionally, a control unit inside the MFP 100 and a control unit inside the post processing device 150 are connected so as to be able to communicate via a connector and a cable not illustrated.

(2) Structure of Sheet Ejection Unit of MFP 100

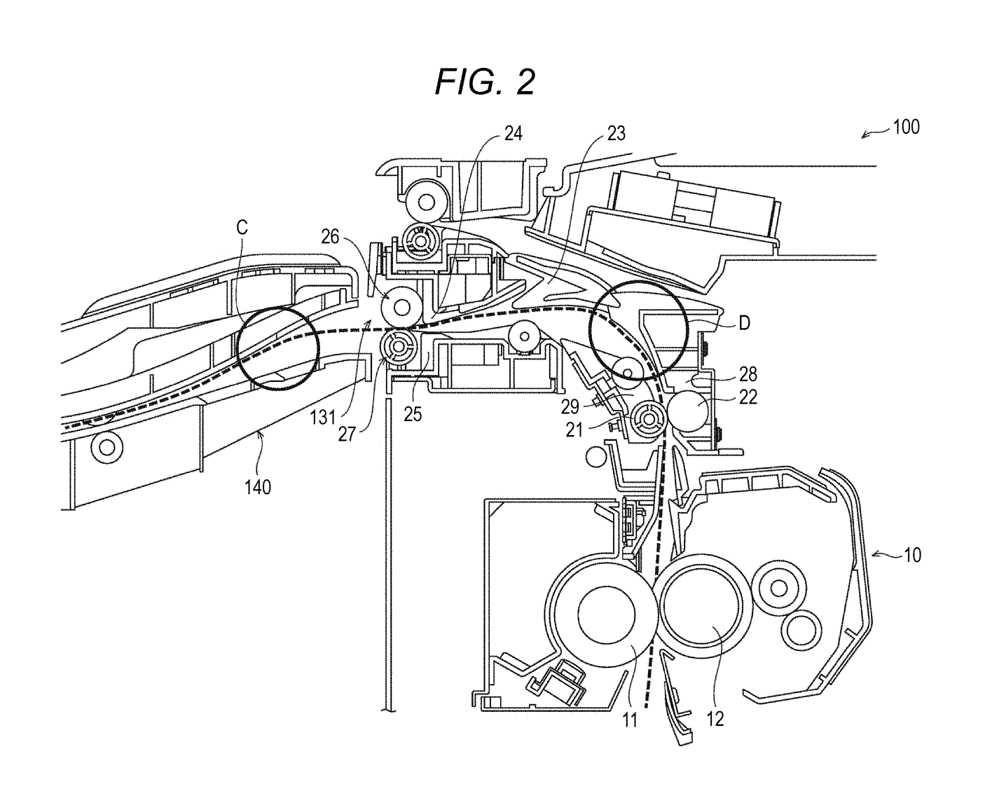

FIG. 2 is a schematic view illustrating a structure of a range from the fixing device of the MFP 100 to a sheet passageway of the relay unit 140 in the image forming system formed by coupling the post processing device 150 to the MFP 100.

A broken line in FIG. 2 indicates a sheet conveyance route.

The fixing device 10 includes a heat roller 11 and a pressure roller 12, and a sheet transferred from a lower side and having no toner image fixed passes through a nip between the heat roller 11 and the pressure roller 12, thereby thermally fixing a toner image onto the sheet. The toner image is formed on the sheet on the heat roller 11 side.

The sheet fixed with the toner image is further conveyed to a downstream side via a pair of post-fixing conveyance rollers 21, 22, guided by guide members 28, 29, 23, 24, 25, and then advances to a pair of sheet ejection rollers 26, 27 while the sheet is largely curved leftward at a portion D.

Note that the guide member 23 also functions as a switching claw that switches a conveyance path of a sheet in order to guide the sheet toward an upper reversing path at the time of executing double-sided printing, but a description thereof will be omitted here.

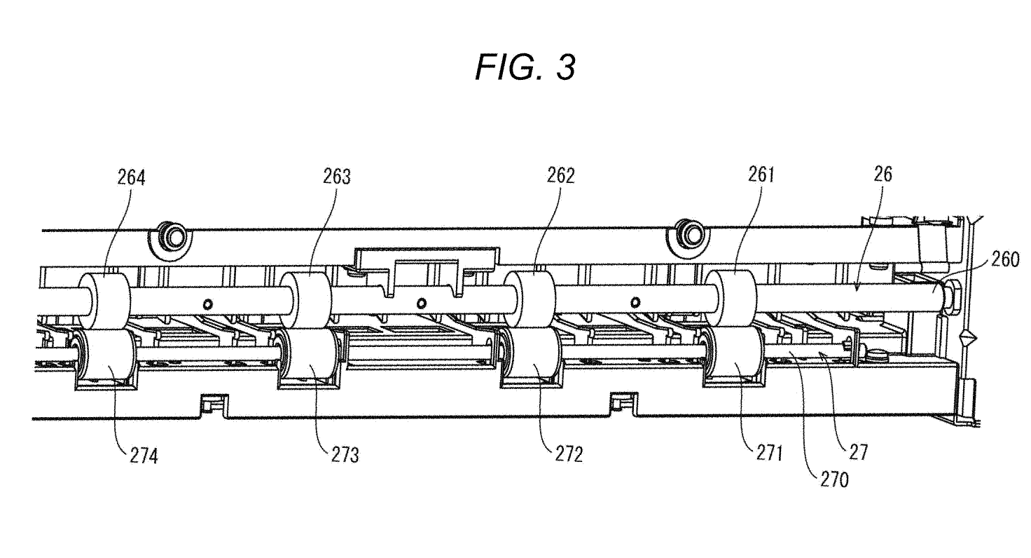

FIG. 3 is a perspective view of a pair of sheet ejection rollers 26, 27 of the MFP 100 in the view from the sheet ejection port 131 side. Similar to rollers of other conveyance systems, the sheet ejection rollers 26, 27 also have short rollers (hereinafter referred to as “sub-rollers” in this specification) 261, 262, 263, . . . and 271, 272, 273, . . . installed respectively in shafts 260 and 270 at predetermined intervals, and a nip is formed between a pair of sub-rollers facing each other. Meanwhile, in the present embodiment, the respective sub-rollers are arranged at positions axially and bilaterally symmetric with respect to a sheet passage center (position where a center in a width direction of a sheet passes in a machine model that conveys a sheet at center reference).

(3) Causes of Wrinkle in Relay Unit 140

In the related art, a folded wrinkle is frequently formed on a sheet at a curved portion C (FIG. 2) in a sheet passageway of the relay unit 140.

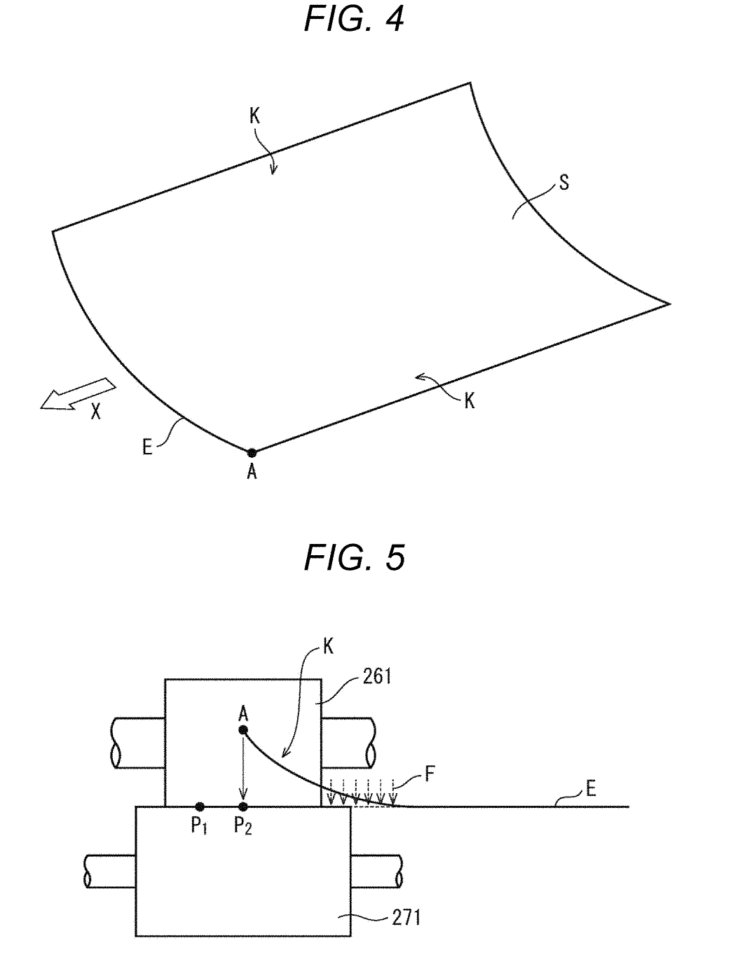

In other words, curls K in which both of end regions in the width direction orthogonal to a sheet conveyance direction X are warped upward is likely to be formed as illustrated in FIG. 4 in a case where water content of a sheet is not uniformly evaporated by heating at the time of passing through the fixing device 10, and then the sheet is conveyed along a conveyance path (curved portion D) curved toward the pair of sheet ejection rollers 27, 28 after the fixing.

As described in FIG. 3, since each of the pair of sheet ejection rollers 26, 27 has the sub-rollers arranged at the predetermined intervals, the end region in the width direction (hereinafter simply referred to as “end region”) of the curled sheet may enter a nip between each pair of sub-rollers depending on a sheet size.

FIG. 5 illustrates a positional relation between an edge E of a leading end of a sheet S and sub-rollers 261, 271 in this case in the view from an upstream side of a sheet conveyance direction of the sheet ejection rollers 26, 27 (hereinafter simply referred to as “upstream side”).

Since the sheet is curled in the width direction as illustrated in FIG. 5, a point A at an end of the edge E of the leading end of the sheet in FIG. 4 contacts a surface of the sub-roller 261 at a position higher than the nip position between the pair of sub-rollers 261, 271, and rolled into the nip as it is, and then enters the nip at a position P2. In a case where the sheet is not curled and the edge E is linear, the point A is to be nipped at a position P1, and therefore, the sheet is tucked in a direction to a sheet passage center by a distance between P1 and P2 and then ejected in this nipped state.

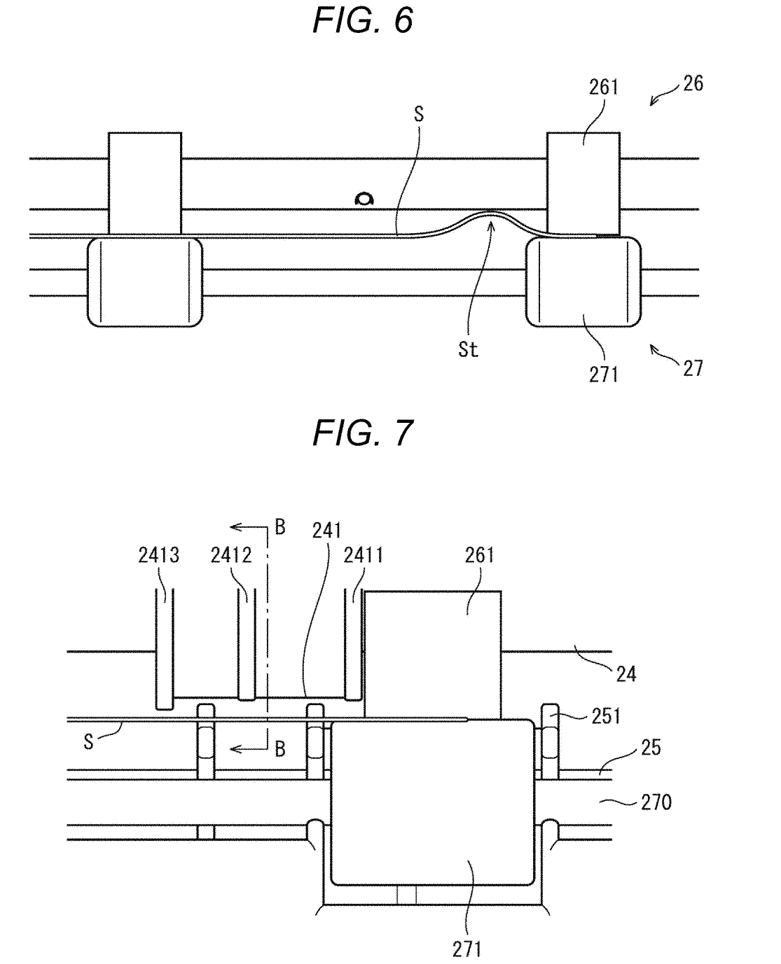

Then, as illustrated in a view from a downstream side in the sheet conveyance direction (ejection side) of FIG. 6, it can be considered that a folded wrinkle is formed because a deflection St is caused in the sheet S on an immediately inner side of the nip between the sub-rollers 261, 271 (sheet passage center side), and the sheet is ejected to the passageway of the relay unit 140 as it is, and when this portion abuts an upper guide surface of the curved portion C (FIG. 2), the sheet advances in a folded manner by strong tensility of the deflection St.

(4) Curl Pressing Member (Curl Correction Member)

Therefore, it can be said that a wrinkle formed on a sheet at the relay unit 140 is caused by a fact that an end region of a sheet having passed through the fixing device 10 is curled in a manner warped upward.

Therefore, the inventor of the present invention considers correcting such a curl in the sheet end region before the sheet contacts the pair of sheet ejection rollers 26, 27.

As illustrated in FIG. 2, a guide member on an upper side (hereinafter referred to as “upper guide member”) 24 and a guide member on a lower side (hereinafter referred to as “lower guide member”) 25 are provided immediately before an upstream side of the pair of sheet ejection rollers 26, 27 in order to guide a sheet in the direction of the pair of sheet ejection rollers 26, 27.

FIG. 7 is a view illustrating a positional relation between the sub-rollers 261, 271, upper guide member 24, and lower guide member 25 in the view from the sheet ejection port 131 side. Meanwhile, in FIG. 7, only the sub-roller 261 is illustrated omitting illustration of the shaft 260 of the sheet ejection roller 26 such that a shape of the upper guide member 24 can be easily grasped.

As illustrated in FIG. 7, ribs 2411, 2412, 2413 of the upper guide member 24 project downward at positions close to a sheet passage center side in the axial direction (axial center side of the sheet ejection roller) of the upper sub-roller 261, and a guide plate 241 having a plate shape is formed in a manner connecting lower ends of these ribs. This guide plate 241 plays a role to press, downward, a curl formed on a sheet end region to correct the curl. In this sense, the guide plate 241 can be referred to as a curl pressing member (curl correction member).

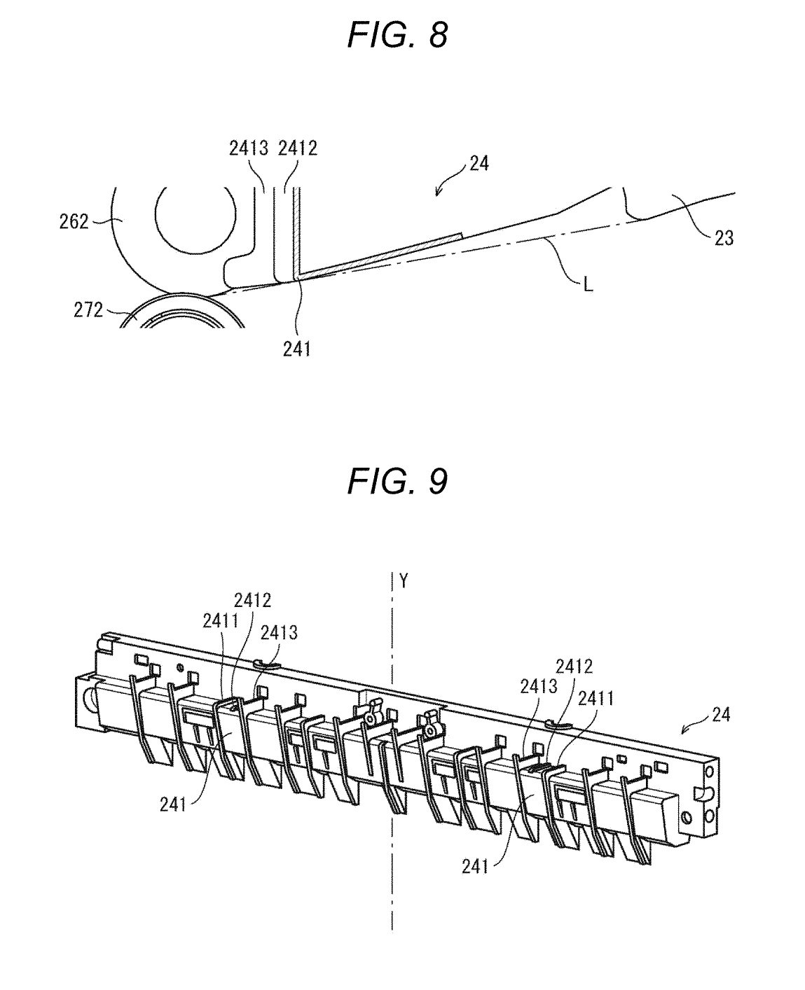

FIG. 8 is a schematic view illustrating a cross section taken along a line B-B in FIG. 7.

In FIG. 7, one dot chain line L is a virtual line indicating a movement trajectory of a sheet end that is expected to be guided to the nip between the pair of sub-rollers 261 and 271 by the guide member 23 and the like on the upstream side of the guide plate 241 in a case where no curl K in the width direction is formed on the sheet.

In the present embodiment, a lowermost portion of the guide plate 241 contacts this virtual line L, and does not project lower than the virtual line L. It can be considered that the guide plate is not needed to project lower than the virtual line L in order to press and correct a curl in an end region of a sheet, and furthermore, in a case where the guide plate 241 projects lower than the virtual line L and a thick sheet is conveyed, a streak caused by pressing action of the guide plate 241 may remain on a surface of the thick sheet because the thick sheet has strong tensility.

Of course, as far as the lowermost portion of the guide plate 241 projects lower than a guide surface of the upper guide member 24 in the related art even without necessarily reaching and contacting the virtual line L, a certain curl correction effect can be obtained.

FIG. 9 is a perspective view of the upper guide member 24 in the view from the lower side (sheet conveyance path side). As illustrated in FIG. 9, a pair of guide plates 241 projecting to a side nearer than other guide portions (i.e., sheet conveyance path side) are provided at positions symmetric with respect to a center Y in a longitudinal direction of the upper guide member 24 (position coinciding with the sheet passage center).

The guide plates 241 thus formed act such that force F indicated by broken lines in FIG. 5 press an end region of a sheet downward before the sheet enters a nip between sub-rollers, and therefore, the end region of the sheet can enter the nip between the sub-rollers 261 and 271 in a state that a curl at the end region in the width direction of the sheet is corrected.

As a result, the deflection St (FIG. 6) caused on the inner side of the sub-rollers where the end region of the sheet passes through in the related art is eliminated (FIG. 7), and a sheet is smoothly curved along the guide surface and no folded wrinkle is caused when the sheet passes through a curved portion like the curved portion C (FIG. 2) in the conveyance path on the more downstream side of the nip.

Meanwhile, as illustrated in FIG. 7, an axial position of the pressing member including the ribs 2411 to 2413 and the guide plates 241 is preferably positioned as close as possible to the sub-roller 261 in a range not contacting a side portion of the sub-roller 261. The reason is that the correction effect is more increased because a curl caused at the end region of the sheet can be pressed at a position closest to the nip.

Additionally, in a case where an axial length of the guide plate 241 is too long, excessive friction may be applied to a sheet and sheet jam may be caused. Therefore, a width of about 8 mm to 26 mm may be preferable.

### Modified Example

The embodiment of the present invention has been described above, but needless to mention that the present invention is not limited to the above-described embodiment and the following modified examples are conceivable.

(1) In the above embodiment, the MFP 100 is provided with the curl correction guide plate projecting downward and positioned close to the axially inner side of the pair of sub-rollers of the guide member where an end region of a sheet having a prescribed size passes through. The prescribed size is preferably a size corresponding to a sheet size having a maximum width that can be used at least in the MFP 100. The reason is that the larger the sheet width is, the larger a warped amount at the sheet end is and the larger a deflection St is when the end is nipped, and there is high necessity to correct such a deflection in advance.

In this case, the guide plate 241 as the pressing member is provided close to the sheet passage center side of pairs of sub-rollers located on both of outermost sides (in the present embodiment, the pair of sub-rollers 261, 271 and a pair of sub-rollers located at positions symmetric to the pair of sub-rollers 261, 271 with respect to the sheet passage center).

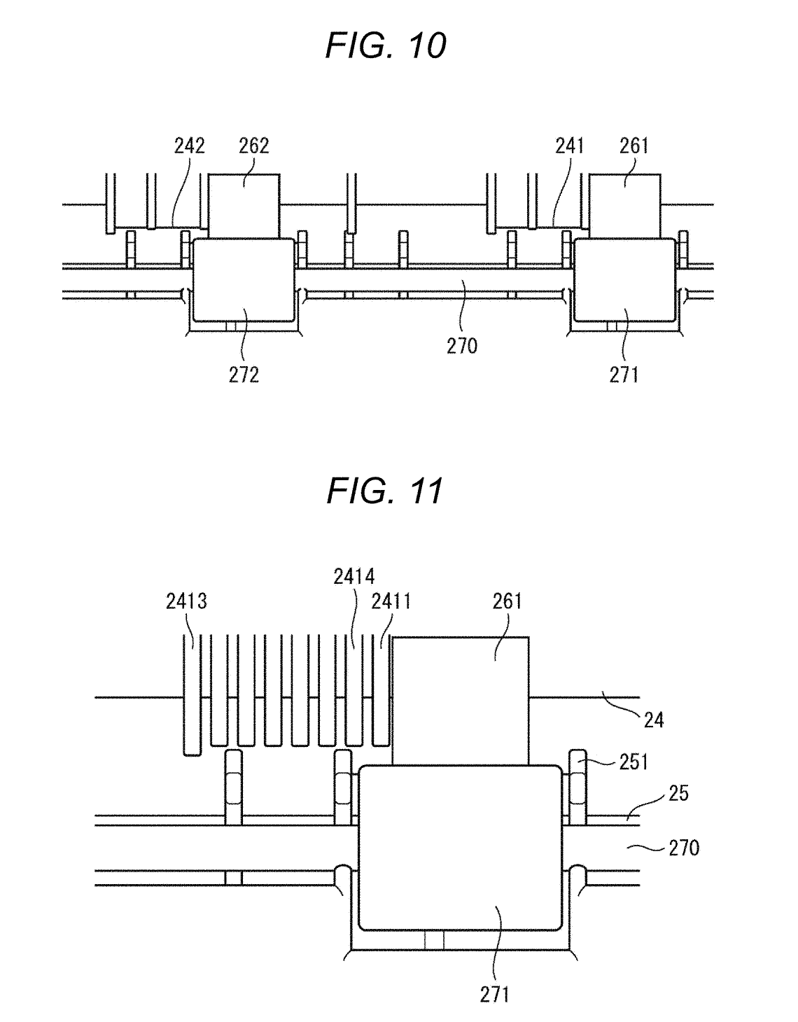

Needless to mention, any size of a sheet on which a folded wrinkle is possibly caused may be handled by providing, as partly illustrated in FIG. 10, the guide plate 242 for curl correction at a position close to an axially inner side of a pair of sub-rollers 262, 272 that forms a nip to nip an end region of a sheet of a different size having a smaller width than the sheet nipped by the nip between the pair of sub-rollers 261, 271.

Meanwhile, in the present specification, the wording “a pair of sub-rollers nips an end region of sheet (nipping)” is intended to include not only a case where an edge (point A) in the width direction of the sheet is nipped by the nip between the pair of sub-rollers 261, 271 as illustrated in FIG. 5 but also a state in which an edge in the width direction edge of the sheet protrudes outward from the nip by a predetermined amount (e.g., about 10 mm) as a result of curl correction. The reasons is that in a case of having no guide plate 241 to correct a curl, the deflection St (FIG. 6) is also caused in this case on the inner side of the nip due to a similar reason described in FIG. 5.

(2) In the above-described embodiment, the plate-like guide plate 241 is provided for curl correction, but not limited thereto, a similar effect can be obtained in correcting a curl at an end region of a sheet also by providing, at axially close intervals, a plurality of ribs 2414 each having a lower end extending to a position almost same as a lower surface of each guide plate 241 as illustrated in FIG. 11.

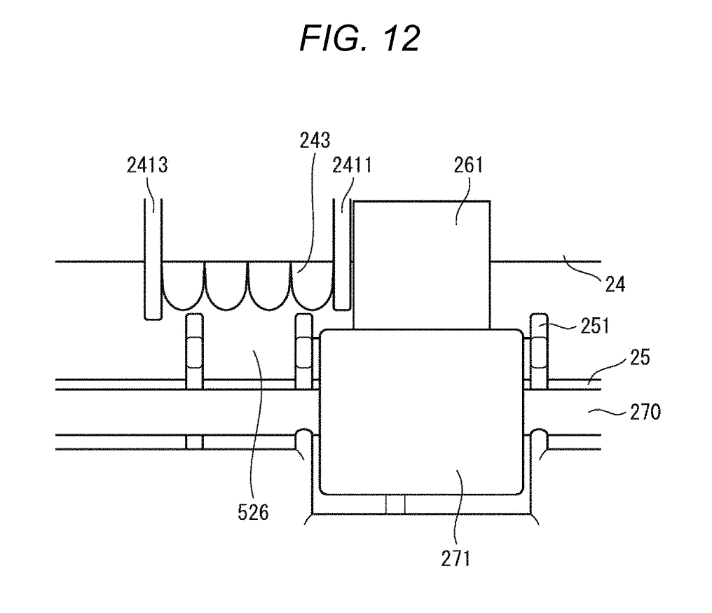

Additionally, as illustrated in FIG. 12, a plurality of protrusions 243 may be disposed densely in the axial direction, instead of the ribs 2414.

In short, as far as a member is provided on the upstream side of a pair of sub-rollers nipping an end region of a sheet plays a role as the pressing member by pressing and correcting a curl caused at the end region of the sheet, a shape of the member may be any shape.

(3) Meanwhile, in the above-described embodiment, the guide plate 241 is provided on the upper guide member 24 side because a sheet has a route to pass the fixing device 10 from the lower side to the upper side and then advance to the pair of sheet ejection rollers 26, 27 via the curved portion D. The reason is that the sheet end region tends to be warped to an outer side of the curved portion D. Therefore, in a case of a machine model having a conveyance path in which a sheet passes the fixing device 10 from an upper side to a lower side, and is curved, and then reaches a sheet ejection roller, the guide plates 241 are preferably provided at the lower guide member 25 located on the outer side in the curved direction of the conveyance path.

(4) In the above-described embodiment, the MFP is described as the image forming device, but the image forming device may be a facsimile machine or a machine exclusively used as a printer as far as the image forming device is an electrophotographic image forming device including a fixing device and a pair of sheet ejection rollers at a final stage regardless of monochrome or color.

Additionally, in a case where the image forming device is not an in-body paper ejection type image forming device, the relay unit 140 is not necessary, and even in a case where a sheet is directly ejected to the passageway of the post processing device 150, the effects of the present invention can be obtained when there is a curved portion in the passageway of the post processing device 150.

(5) The above-described embodiment and modified examples may be combined as much as possible.

The present invention is useful as a technology to suppress a wrinkle caused in a sheet in a case of further conveying, via a different conveyance path, a sheet having passed through the fixing device and ejected from a pair of sheet ejection rollers.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming device having a guide member that guides a sheet having passed through a fixing device to a pair of sheet ejection rollers, wherein
the pair of sheet ejection rollers has a plurality of pairs of sub-rollers installed at a rotary shaft at predetermined intervals, and a nip is formed by a pair of sub-rollers facing each other,
the plurality of pairs of sub-rollers includes a specific pair of sub-rollers that nips an end region in a width direction orthogonal to a sheet conveyance direction when a sheet of a prescribed size passes, and
the guide member includes a pressing member that presses a curl in a direction to correct the curl, the curl being caused at an end region in the width direction of the sheet on a more upstream side in the sheet conveyance direction than a position where a leading end of the sheet enters a nip between the specific pair of sub-rollers.

2. The image forming device according to claim 1, wherein the pressing member is provided close to an axial center side of the specific pair of sub-rollers of the sheet ejection rollers in the view from the sheet conveyance direction.

3. The image forming device according to claim 1, wherein in a case where no curl is caused in a width direction of the sheet, a portion of the pressing member contacting a sheet does not protrude more than a trajectory passed through by the sheet that is guided by a guide member provided on a more upstream side in the sheet conveyance direction than the pressing member and reaches a nip between the sheet ejection rollers.

4. The image forming device according to claim 1, wherein a conveyance path from the fixing device to the sheet ejection rollers is curved, and the pressing member is provided in a guide member located on an outer side in a curved direction of the conveyance path.

5. The image forming device according to claim 1, wherein the pressing member includes a plate-like member formed at the guide member.

6. The image forming device according to claim 1, wherein the pressing member includes a rib or a protrusion formed at the guide member.

7. The image forming device according to claim 1, wherein the specific pair of sub-rollers is a pair of sub-rollers located on an outermost side among the plurality of pairs of sub-rollers in the view of the sheet conveyance direction.

8. The image forming device according to claim 7, wherein there is a pair of sub-rollers that nips an end region of a sheet having a different width other than the pair of sub-rollers located on the outermost side, and a pressing member is provided close to an axial center side of this pair of sub-rollers of the sheet ejection rollers in the view from the sheet conveyance direction.
